(19) United States
(12) Patent Application Publication
(10) Pub. No.: US 2016/0185437 A1
(43) Pub. Date: Jun. 30, 2016

(54) TAIL CONE OF AN AIRCRAFT

(71) Applicant: Airbus Operations S.L., Getafe (ES)

(72) Inventor: Elena Arevalo Rodriguez, Getafe (ES)

(21) Appl. No.: 14/979,081

(22) Filed: Dec. 22, 2015

(30) Foreign Application Priority Data
Dec. 29, 2014 (EP) 14382578.4

(51) Int. Cl. B64C 1/06; B64F 5/00; B64C 1/12

(52) U.S. Cl. CPC B64C 1/068; B64C 1/06; B64C 1/12; B64F 5/0009

(57) ABSTRACT

A tail cone of an aircraft, more specifically a tail cone made of composite materials comprising an internal skin, an external skin surrounding the internal skin, longitudinal structural members located on the inner face of the internal skin in the longitudinal direction of the tail cone, and transversal structural members located between the external skin and the internal skin in the transverse direction of the tail cone.

### CROSS-REFERENCES TO RELATED APPLICATIONS

This application claims the benefit of the European patent application No. 14382578.4 filed on Dec. 29, 2014, the entire disclosures of which are incorporated herein by way of reference.

### FIELD OF THE INVENTION

The present invention refers to a tail cone of an aircraft. More specifically it refers to a tail cone made of composite materials.

### BACKGROUND OF THE INVENTION

A known tail cone comprises longitudinal structural members, transversal structural members and a skin.

The skin is internally reinforced with the longitudinal and transversal structural members such that the structural members are located on the inner face of the skin. Stringers, beams and frames can be mechanically attached to the skin or optionally stringers can be cocured to the skin while the other elements are riveted to the skin.

The skin has to fulfill two different conditions, firstly to support structural loads mainly derived from the attachment of the auxiliary power system APS which is attached to the structure of the compartment usually through struts extending between the auxiliary power system and strong points in the structure corresponding to frames-beams crossings. Additionally the skin has to be configured to support aerodynamic loads by having a geometry with a low resistance to the the aerodynamic loads.

The longitudinal structural members, for instance, stringers and beams, are located in the longitudinal direction of the tail cone, taking the flight direction as longitudinal direction. More specifically, beams reinforce cut outs or areas in which local loads are introduced.

The transversal structural members, such as frames, are located transversal to the longitudinal direction of the tail cone.

Both elements, longitudinal and transversal, intersect each other in two types of intersections:

Intersections between stringers and frames in which both elements are kept continuous and furthermore frames have holes, called mouseholes, for allowing the stringers to pass through them.

Intersections between beams and frames in which one of the two elements must be ended at the intersection so that the other element can be kept continuous, being both elements further joined with auxiliary joining parts.

Manufacturing the previously mentioned structural elements and assembling them to the skin, including all the intersections between frames and beams is a difficult and time consuming task and in addition the intersections between longitudinal and transversal elements increase the weight of the structure because auxiliary joining parts have to be provided.

### SUMMARY OF THE INVENTION

An aim of the invention is to simplify the above mentioned structure of the tail cone in order to make it easy to manufacture and assemble and to increase the structural efficiency of the tail cone.

The claimed invention is characterized in that the tail cone comprises:

an internal skin,

an external skin which surrounds the internal skin,

longitudinal structural members located on the inner face of the internal skin in the longitudinal direction of the tail cone, and

transversal structural members located between the external skin and the internal skin in the transverse direction of the tail cone.

The problem previously mentioned in the background of the invention related to intersections between longitudinal and transversal structural elements has been solved by providing two skins, an internal skin and an external skin and also providing the longitudinal structural elements on the inner face of the internal skin and the transversal structural elements on the outer face of the internal skin or, in other words, between the internal and the external skins. This configuration eliminates the crossing between longitudinal and transversal structural elements.

Another objective of the claimed configuration is to ease the manufacturing process of the internal skin and the reinforcing elements. Since the internal skin doesn't have to fulfil aerodynamic constraints, its cross section could be designed to be manufactured more easily in order to save time and cost, for instance, having flat walls in order to make its manufacturing process easier and cheaper. Additionally, the head of the frames, that are attached to the internal skin, is also straight while the foot of the frames follows the shape of the external skin, as a consequence, the foot and the head of the frames are not parallel. In addition, the frame can be made in portions that are assembled afterwards forming the whole frame. Consequently as the head of the frames is straight and the frames can be manufactured in parts, the manufacturing process is simplified.

Moreover, the tail cone is manufactured such that its ability to support loads coming from the attachment of the auxiliary power system APS is increased. This is due because the attachment can be made to a strong point, that is, to a reinforced region corresponding to the joint of a frame, a beam and the internal skin.

On the other hand, the external skin could be suitable for supporting aerodynamic loads or additionally it can also be designed both for withstanding aerodynamic and structural loads providing more flexibility to the tail cone.

A further additional advantage is that in case of impacts during handling operations, the replacement or repair of the external skin can be quickly done because it is joined to a fewer number of structural members, mainly to the transversal structural members and, in some configurations, to some longitudinal structural members. Moreover when the external skin is joined by reversible means, the assembly and disassembly is eased and a reduction of the hours of the aircraft on ground is achieved. Additionally, in an embodiment having a frame split into sections in case of impacts that damage a portion of the frame, only the damaged section needs to be replaced instead of the whole frame.

Additionally, routing an the electrical system and lights, could be placed between the internal skin and the external skin, without fireproof requirements because they would be located out of the compartment in which a fire can arise.

In summary, the weight is optimized, the manufacturing method is simplified and the number of parts is reduced.

It is also an object of the claimed invention a manufacturing method of a tail cone that comprises the following steps:

providing an internal skin,

locating longitudinal structural members on the inner face of the internal skin in the longitudinal direction of the tail cone, and

locating transversal structural members on the outer face of the internal skin in the transverse direction of the tail cone,

providing afterwards an external skin surrounding the transversal structural members, and

attaching the external skin to the transversal structural members or to the
internal skin.

It is also an object of the claimed invention to provide an aircraft that comprises a tail cone according to the preceding technical features.

### BRIEF DESCRIPTION OF THE DRAWINGS

To complete the description and in order to provide for a better understanding of the invention, a set of drawings is provided. The drawings form an integral part of the description and illustrate preferred embodiments of the invention. The drawings comprise the following figures:

FIG. 1 is a schematic perspective view of a tail cone of the state of the art.

FIG. 2 is a schematic view of a cross section of an embodiment of the tail cone.

FIG. 3 is a schematic perspective view of the embodiment of the tail cone corresponding to FIG. 2.

FIG. 4a is a schematic view of a cross section of the struts supporting the auxiliary power system of the state of the art.

FIG. 4b is a schematic view of a cross section of an embodiment of the invention showing the attachment of the struts supporting the auxiliary power system to the fuselage structure.

FIG. 5a is a schematic view of a cross section of an additional embodiment of the invention showing the attachment of the struts supporting the auxiliary power system to the fuselage structure.

FIG. 5b shows a detail of the attachment of the auxiliary power system disclosed in FIG. 5a.

### DETAILED DESCRIPTION OF THE PREFERRED EMBODIMENTS

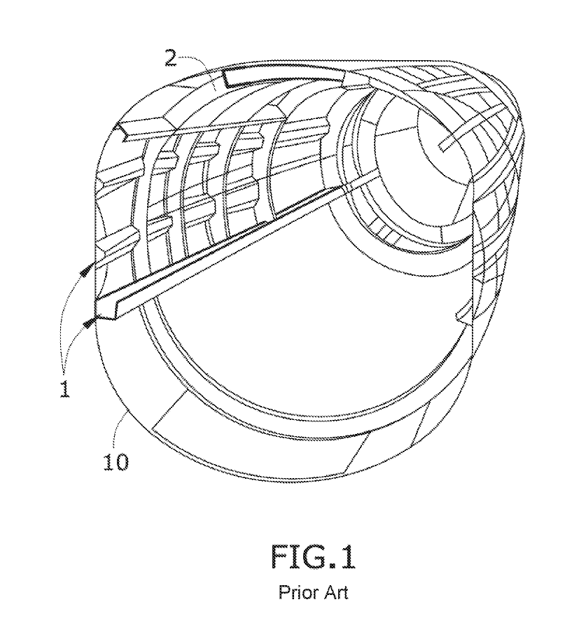

FIG. 1 shows a known tail cone comprising a skin (10), longitudinal structural members (1) located in the longitudinal direction of the tail cone and attached to the inner face of the skin (10), and transversal structural members (2) located in the transverse direction of the tail cone and also attached to the inner face of the skin (10).

The longitudinal structural members (1) shown in the figures are stringers (6) and beams (5) while the transversal structural members (2) mainly comprise frames (2). The stringers (6) could be omega or T shaped, and the beams (5) could have a C, J or H cross-section. The stringers (6) and beams (5) have intersections with the frames (2) as explained in the background of invention. The elements are made of carbon fiber reinforced polymer.

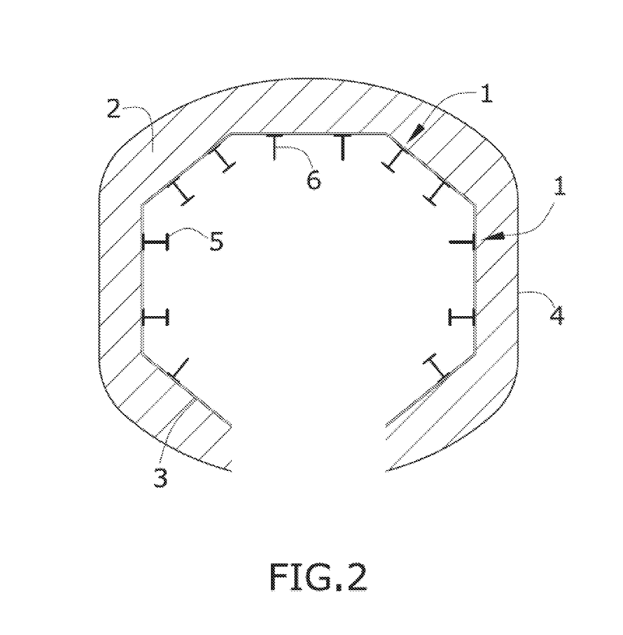

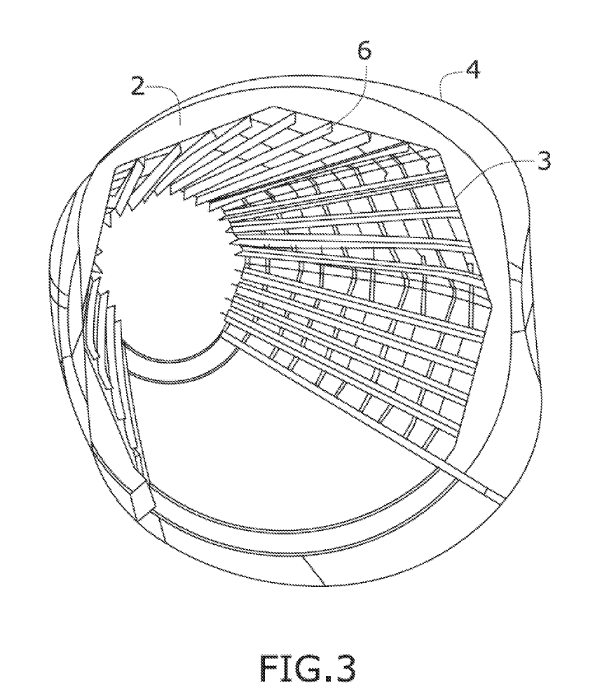

FIGS. 2 and 3 show an embodiment of a tail cone incorporating the present invention and made of composite material wherein the transversal structural members (2) are located between the external skin (4) and the internal skin (3). Additionally, the longitudinal structural members (1) are located on the inner face of the internal skin (3).

As frames (2) are placed on the outer face of the internal skin (3) and stringers (6) and beams (5) on the inner face of the internal skin (3), no intersections exist between frames (2) and stringers (6) or beams (5), therefore the manufacturing process is easier as no cut outs (mouseholes) have to be made. Moreover, the head of the frames (2) is straight and the frames (2) can be manufactured in parts. Not having the cut outs provides the additional advantage of increasing the structural efficiency of the frames (2). Additionally, as the auxiliary joining parts between frames (2) and beams (5) are avoided, the number of parts is reduced implying reduced costs and weight savings.

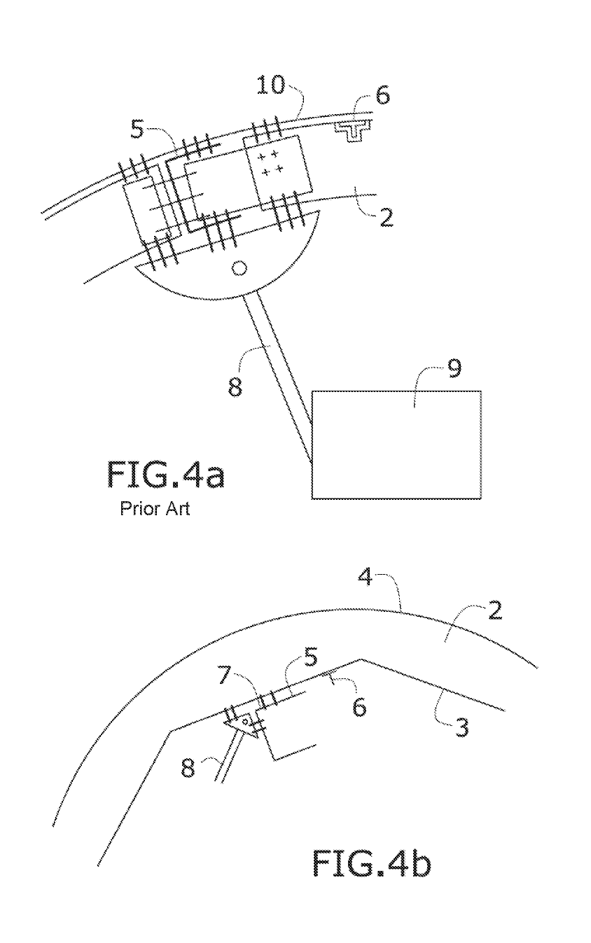

An additional advantage is that, in the state of the art, as frames (2) and beams (5) cross each other, the means for supporting the auxiliary power system APS (9), that are struts (8) in the shown embodiment, are joined in a complex way, by means of a high number of pieces, at frame (2)—beam (5) intersections as shown in FIG. 4a. In the configuration according to the invention, these struts (8) supporting the auxiliary power system (9) are joined to strong points in the structure formed by the internal skin (3), the foot (7) and the web of the beam (5). These strong points are accessible since the frames (2) are located in the opposite face of the internal skin (3), that leading to a simpler attachment of the APS (9) as can be seen in FIG. 4b.

The internal skin (3) doesn't have to fulfil aerodynamic constraints, therefore the internal skin (3) could be designed having flat walls in order to smooth its manufacturing process.

An additional advantage is that as the head of the frame (2) follows the contour of the internal skin (3), it also has a flat contour making its manufacturing process easier. Moreover, this structural configuration allows the transversal structural members (2) to be easily divided into sections, each section comprising a portion of the head, a portion of the foot and the web of the transversal structural member (2). Afterwards, those sections can be joined by joining parts such that continuity to the web, the head including the inner skin and the foot of the frame (6) is provided.

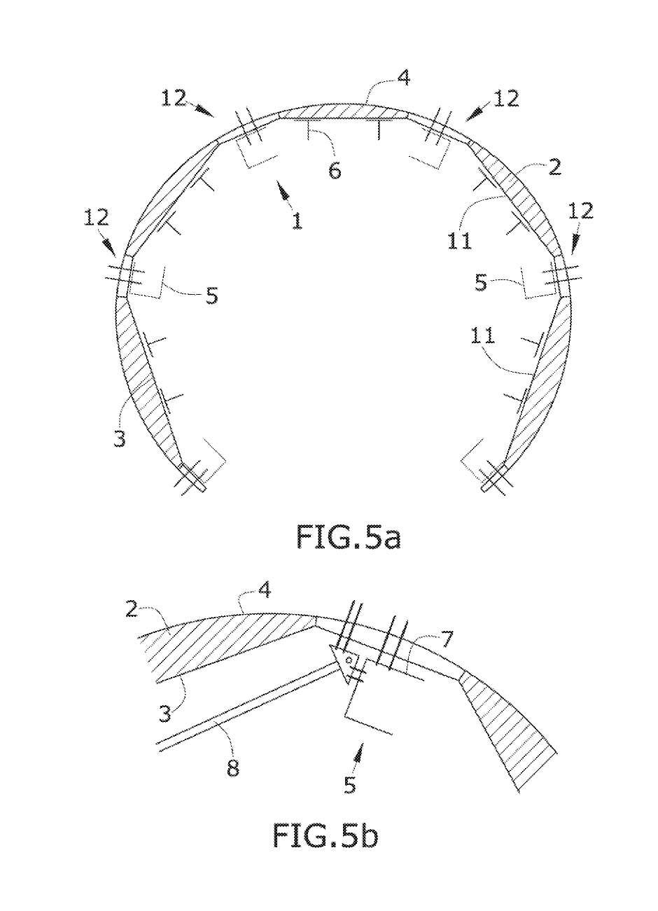

FIGS. 5a and 5b disclose another embodiment in which the frame (2) is also divided into sections (11) that are separated and extend between consecutive points (12) in which the external (4) and the internal skin (3) are joined. Therefore the frame (2) is not continuous and it comprises several independent sections (11) and the internal (3) and external (4) skin are joined at intervals. The beams (5) are located in the points wherein the internal (3) and external (4) skin are joined.

Again, FIG. 5b shows that the struts (8) supporting the auxiliary power system (9) are joined to strong points in the structure formed by the internal skin (3), the foot (7) and the web of the beam (5).

Another advantage of having flat walls is that the internal skin (3) can be designed only noting the structural loads and not the aerodynamic loads, therefore the inner structure can be designed in a simpler way to withstand these structural loads.

As previously stated, the external skin (4) could be suitable for supporting aerodynamic loads or additionally it can also be designed both for withstanding aerodynamic and structural loads. When the external skin (4) only fulfils aerodynamic conditions, as the internal skin (3) has a smaller diameter than a conventional skin (10), a more robust internal skin (3) would be advisable, to the contrary, the external skin (4) can also be prepared to support structural loads.

In order to improve the transfer of loads in the internal skin (3) the transition between adjacent flat walls is made through rounded corners better than through angled corners. Additionally, the skin thickness at the transition zone between consecutive flat walls could be increased.

Thus, the manufacturing method of the embodiment shown in the figures comprises the following steps:

providing an internal skin (3),

locating longitudinal structural members (1) on the inner face of the internal skin (3) in the longitudinal direction of the tail cone, and

locating transversal structural members (2) on the outer face of the internal skin (3) in the transverse direction of the tail cone,

providing afterwards an external skin (4) surrounding the transversal structural members (2), and

attaching the external skin (4) to the transversal structural members (2) or to the internal skin (3) depending of the embodiment.

In the embodiment shown in FIGS. 2 and 4, the external skin (4) is attached to the transversal structural members (2), i.e., to the frames, while in the embodiment shown in FIGS. 5a and 5b, the external skin (4) is attached to the longitudinal structural members (2) and to the internal skin (3) in the points in which the internal (3) and the external (4) skin are joined and there is no transversal structural member (2) inbetween.

The structure can be an integrated structure, that it is to say, a structure in which stringers (6), beams (5), frames (2) and the internal skin (3) are hot formed and afterwards are cocured together in their final position, therefore the internal part can be manufactured in a single piece as a single process known as one shot process, with the appropriate tooling inside and outside the internal skin (3). Afterwards, the external skin (4) is attached to the previous structure.

As previously stated, the external skin (4) could have a structural behavior or only an aerodynamic function like a fairing. In both cases, the external skin (4) is mechanically attached to the transversal structural members (2) or to the internal skin (3). If the external skin (4) has a structural duty, the attachment would be done by rivets and if the external skin (4) fulfills only an aerodynamic objective, the attachment would be done by reversible fastening means. Additionally, in case of having a non-structural external skin (4), the detachment of the skin (4) would be done more easily thanks to the reversible fastening means.

It is also an object of the claimed invention to provide an aircraft that comprises a tail cone according to the preceding technical features.

With the claimed invention, auxiliary joining parts between longitudinal and transversal structural members are avoided, first of all between frames (2) and beams (5) this reducing the number of parts and the total weight. Secondly, between frames (2) and stringers (6) avoiding the need to have cutouts into the frames (2) for allowing continuous stringers (5), this, together with the straight head of the frames and the split into pieces, simplifying the manufacturing process of the frame (2). Because of the need to form mouseholes is avoided, the frame section is not interrupted, and therefore frame structural efficiency is increased, additionally allowing a decrease of the height of the frame.

Additionally, the internal skin (3) can also accomplish with the fireproof requirements.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tail cone of an aircraft comprising:
an internal skin,
an external skin surrounding the internal skin,
longitudinal structural members located on an inner face of the internal skin in a longitudinal direction of the tail cone, and
transversal structural members located between the external skin and the internal skin in the transverse direction of the tail cone.

2. The tail cone according to claim 1, wherein the internal skin comprises flat walls.

3. The tail cone according to claim 2, wherein a transition between adjacent flat walls of the internal skin is made through rounded corners.

4. The tail cone according to claim 2, wherein an internal skin thickness is increased at a transition zone between adjacent flat walls.

5. The tail cone according to claim 1, wherein the transversal structural members are divided into sections, each section comprising a portion of a head and a portion of a foot and web of the transversal structural member.

6. The tail cone according to claim 5, wherein the different sections of the transversal structural members are separated from each other and extend between consecutive points in which the external and the internal skin are joined.

7. The tail cone according to claim 1, further comprising connecting elements for an auxiliary power system, said connecting elements being joined to the foot and the web of the longitudinal structural members and to the internal skin.

8. The tail cone according to claim 7, wherein the different sections of the transversal structural members are separated from each other and extend between consecutive points in which the external and the internal skin are joined and the longitudinal structural members for connecting to an auxiliary power system are located at points where the internal and external skin are joined.

9. The tail cone according to claim 1, wherein the internal skin, the longitudinal structural members and the transversal structural members are an integrated structure manufactured as a single piece.

10. An aircraft comprising a tail cone which comprises:
an internal skin,
an external skin surrounding the internal skin,
longitudinal structural members located on the inner face of the internal skin in the longitudinal direction of the tail cone, and
transversal structural members located between the external skin and the internal skin in the transverse direction of the tail cone.

11. A method of manufacturing a tail cone of an aircraft, comprising the following steps:
providing an internal skin,
locating longitudinal structural members on an inner face of the internal skin in a longitudinal direction of the tail cone,
locating transversal structural members on an outer face of the internal skin in a transverse direction of the tail cone,
providing afterwards an external skin surrounding the transversal structural members, and
attaching the external skin to the transversal structural members or to the internal skin.

12. The method according to claim 11, wherein the longitudinal and transversal structural members and the internal skin are firstly hot formed and afterwards cocured together to form an integrated structural part.

13. The method according to claim 11, wherein the external skin is firstly cured and afterwards is mechanically attached to the transversal structural members or to the internal skin.

14. The method according to claim 13, including the step of attaching the external skin to the transversal structural members or to the internal skin by rivets.

15. The method according to claim 13, including the step of attaching the external skin to the transversal structural members or to the internal skin by reversible fasteners.
